(19) United States
(12) Patent Application Publication
(10) Pub. No.: US 2023/0283404 A1
(43) Pub. Date: Sep. 7, 2023

(54) QUADRANT-BASED FAULT DETECTION AND LOCATION

(71) Applicant: ARRIS Enterprises LLC, Suwanee, GA (US)

(72) Inventors: Thomas J. CLOONAN, Lisle, IL (US); Parasuram RANGANATHAN, Brampton (CA); Ayham AL-BANNA, Irving, TX (US); Kevin S. WIRICK, Encinitas, CA (US); Mircea ORBAN, Toronto (CA)

(73) Assignee: ARRIS Enterprises LLC, Suwanee, GA (US)

(21) Appl. No.: 18/114,269

(22) Filed: Feb. 26, 2023

Related U.S. Application Data
(60) Provisional application No. 63/314,460, filed on Feb. 27, 2022.

(51) Int. Cl. H04L 1/00; H04L 43/0829

(52) U.S. Cl. CPC H04L 1/0041; H04L 1/0045; H04L 43/0829

(57) ABSTRACT

Devices, systems and methods that determine both the existence of, and location where, packets were dropped in transit between a sending device and a receiving device. A network monitoring unit is located between the sending and receiving devices, and monitors packets exchanged between the two to determine the location where packets were dropped.

### CROSS REFERENCE TO RELATED APPLICATIONS

This application claims benefit of priority under 35 USC 119(e) to the filing date of U.S. Provisional Application No 63/314,460 filed on Feb. 27, 2022, the contents of which are hereby incorporated by reference in its entirety.

### BACKGROUND

The subject matter of this application relates to improved systems and methods that deliver CATV, digital, and Internet services to customers.

Cable Television (CATV) services have historically provided content to large groups of subscribers from a central delivery unit, called a “head end,” which distributes channels of content to its subscribers from this central unit through a branch network comprising a multitude of intermediate nodes. Modern Cable Television (CATV) service networks, however, not only provide media content such as television channels and music channels to a customer, but also provide a host of digital communication services such as Internet Service, Video-on-Demand, telephone service such as VoIP, and so forth. These digital communication services, in turn, require not only communication in a downstream direction from the head end, through the intermediate nodes and to a subscriber, but also require communication in an upstream direction from a subscriber and to the content provider through the branch network.

To this end, such CATV head ends included a separate Cable Modem Termination System (CMTS), used to provide high speed data services, such as video, cable Internet, Voice over Internet Protocol, etc. to cable subscribers. Typically, a CMTS will include both Ethernet interfaces (or other more traditional high-speed data interfaces) as well as RF interfaces so that traffic coming from the Internet can be routed (or bridged) through the Ethernet interface, through the CMTS, and then onto the optical RF interfaces that are connected to the cable company’s hybrid fiber coax (HFC) system. Downstream traffic is delivered from the CMTS to a cable modem in a subscriber’s home, while upstream traffic is delivered from a cable modem in a subscriber’s home back to the CMTS. Many modern CATV systems have combined the functionality of the CMTS with the video delivery system (EdgeQAM) in a single platform called the Converged Cable Access Platform (CCAP). Still other modern CATV architectures (referred to as Distributed Access Architectures or DAA) relocate the physical layer (e.g.., a Remote PHY or R-PHY architecture) and sometimes the MAC layer as well (e.g., a Remote MACPHY or R-MACPHY architecture) of a traditional CCAP by pushing it/them to the network’s fiber nodes. Thus, while the core in the CCAP performs the higher layer processing, the remote device in the node converts the downstream data sent by the core from digital-to-analog to be transmitted on radio frequency, and converts the upstream RF data sent by cable modems from analog-to-digital format to be transmitted optically to the core.

Regardless of which architectures were employed, historical implementations of CATV systems bifurcated available bandwidth into upstream and downstream transmissions i.e., data was only transmitted in one direction across any part of the spectrum. For example, early iterations of the Data Over Cable Service Interface Specification (DOCSIS) specified assigned upstream transmissions to a frequency spectrum between 5 MHz and 42 MHz and assigned downstream transmissions to a frequency spectrum between 50 MHz and 750 MHz. Later iterations of the DOCSIS standard expanded the width of the spectrum reserved for each of the upstream and downstream transmission paths, the spectrum assigned to each respective direction did not overlap.

Packet Loss is a natural part of the Internet, occurring in cables, network elements (like routers), etc. The cause can be from noise on a channel (causing the packet’s bits to be corrupted), can be caused by packet congestion in a network element that leads to a buffer overflow (causing the packet to be dropped at the tail of the buffer), or can be caused by the Transmission Control Protocol (TCP) probing for new maximum bandwidth capacities.

TCP and other higher-layer apps (like QUIC- which runs on top of UDP) can ameliorate packet loss by re-transmissions, but this solution increases latencies and also degrades throughputs of the connections in TCP and higher-layers, since it couples into the TCP or higher-layer app congestion control algorithms that limit throughputs as a result of detected packet loss.

When packet losses are causing undesirable side-effects (like higher latencies and lower throughputs), it may be desirable to find a technique that permits network operators to quickly identify the location of the packet loss so that corrective actions can be taken, such as increasing the link capacity on a particular network link or adding more links between network endpoints.

Even when packets are not lost, packet delay and jitter also degrade quality of service in communications networks. Packet delay is the time taken to send data packets over a network connection, and this delay varies based on factors such as network congestion, changes in the path taken by a packet when traversing the network between a source and destination, and variations in buffer depths in routers. The variation in that delay is called jitter, and adversely affects the services provided over the network, particularly in real-time applications, such as video conferencing, VoIP calls, live streaming, online gaming, etc. Jitter is noticed in the form of video or audio artifacts, static, distortion, and dropped calls.

What is desired, therefore, are systems and methods that locate the source of packet loss, packet latency, and/or packet jitter in the network.

### BRIEF DESCRIPTION OF THE DRAWINGS

For a better understanding of the invention, and to show how the same may be carried into effect, reference will now be made, by way of example, to the accompanying drawings, in which:

FIGS. 1A-1C illustrate how packets are sent, received and acknowledged using the Transmission Control Protocol (TCP).

FIG. 2A shows an embodiment of the present disclosure used to determine the location of dropped packets, including a network monitoring unit positioned pursuant to an inline-type architecture.

FIG. 2B shows an embodiment of the present disclosure used to determine the location of dropped packets, including a network monitoring unit positioned pursuant to a hairpin-type architecture.

FIG. 2C shows an embodiment of the present disclosure used to determine the location of dropped packets, including a network monitoring unit positioned pursuant to a hairpin-type architecture.

FIG. 3 shows TCP/IP headers in the forward and reverse directions, each having fields monitored by the network monitoring unit of FIGS. 2A-2C.

FIG. 4 shows how packet loss may be detected by monitoring the TCP/IP headers shown in FIG. 3.

FIG. 5 shows quadrants defined by the location of the network monitoring unit of FIGS. 2A-2C.

FIG. 6A shows a quadrant layout for determining the quadrant of a fault of a packet sent from a server to a client device.

FIG. 6B shows a quadrant layout for determining the quadrant of a fault of a packet sent from a client device to a server.

FIGS. 7A and 7B show a technique of detecting the quadrant of a fault for a packet traveling in a forward direction from a server to a client.

FIGS. 8A and 8B show a technique of detecting the quadrant of a fault for a packet traveling in a reverse direction from a client to a server.

FIGS. 9A and 9B show a system for determining the amount of latency in the server-side and client-side quadrants, respectively.

FIGS. 10A and 10B show a system for determining the amount of latency in the server-side and client-side quadrants, respectively.

FIG. 11 shows an exemplary communications system in which the foregoing systems may be implemented.

### DETAILED DESCRIPTION

As noted previously, packet loss, packet latency, and packet jitter are each phenomenon that adversely impact quality of service provided over a communications network, and therefore any systems or methods that would assist in determining the location of conditions that are causing these phenomena e.g., packets being dropped, would be immensely helpful in managing the network in that it would help operators more quickly locate and correct the issue, leading to greatly improved customer satisfaction. Such solutions would be beneficial in a wide variety of communications architectures and services, including DOCSIS services, PON architectures, any communications system employing routers, including wireless networks such as WiFi and 5G, as well as Citizen’s Broadcast Radio Service (CBRS). The present specification discloses systems and methods that provide such solutions across this broad array of architectures, and in a low-cost manner that that does not require complex additions to the network.

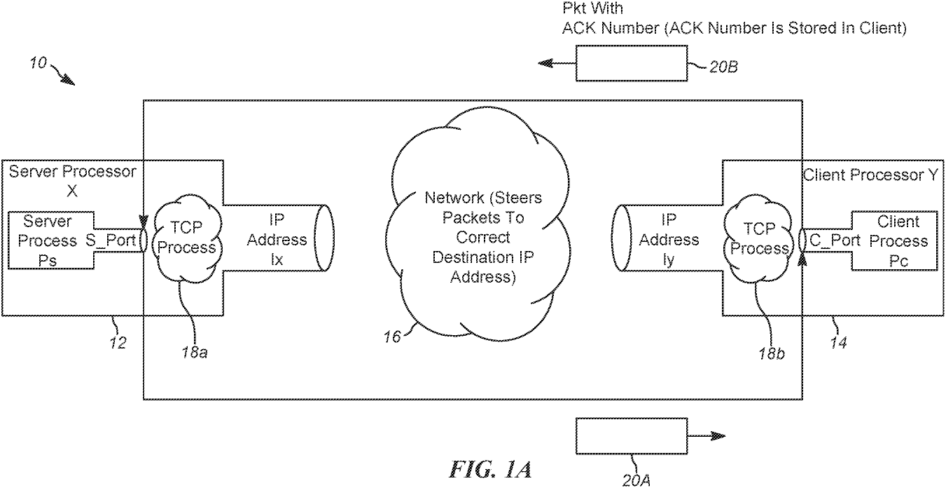

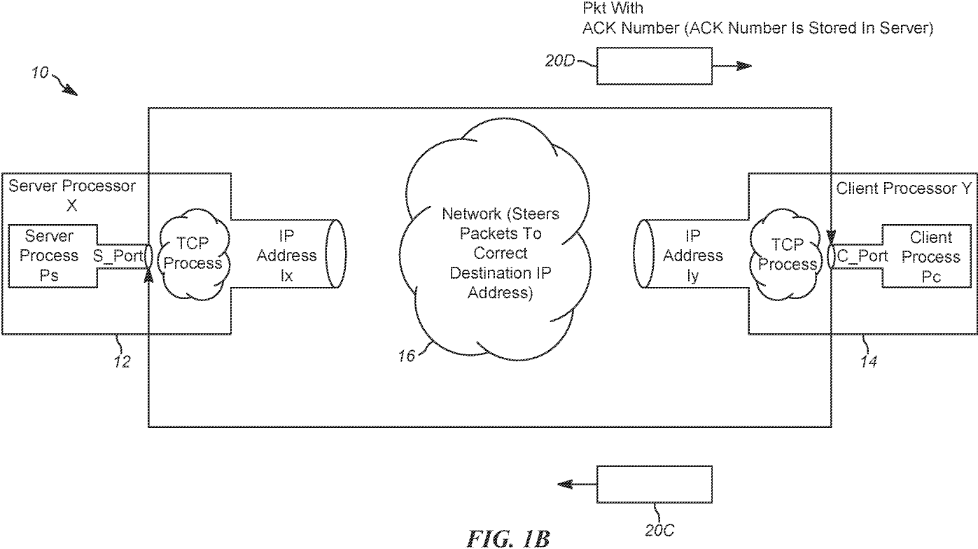

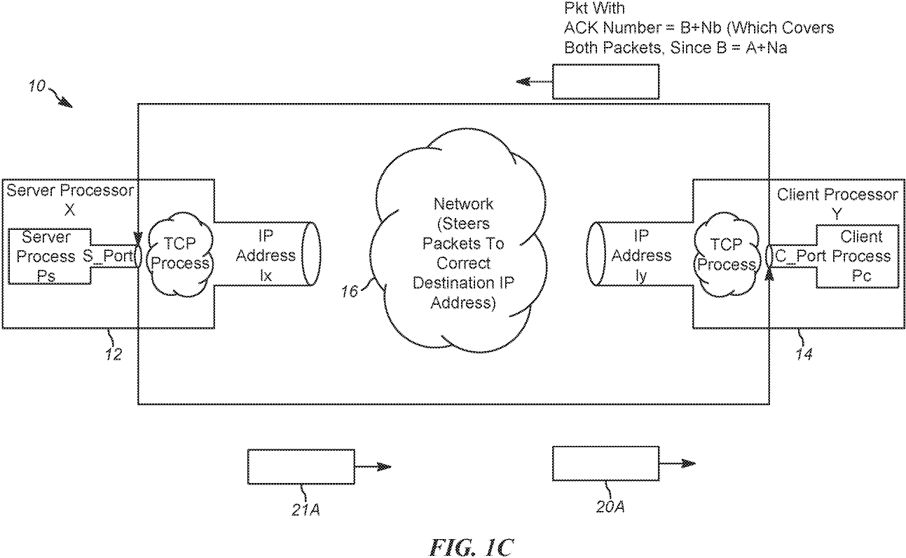

For example, the systems and methods disclosed in the present specification leverage the Transmission Control Protocol (TCP) that is already ubiquitously used in modern communications technologies. FIGS. 1A-1C generally illustrate the TCP process used by the systems and methods disclosed herein. Specifically, these figures show a system 10 in which a server 12 having a processor “X” communicates with a client device 14 with a processor “Y” over a communications network 16 that steers packets between the server 12 and client 14 using those devices’ IP addresses. Preferably, as can be seen in these figures, processes ensuring reliable transmission of the packets and congestion control algorithms are operational via both a server-side TCP process 18a in the server processor X, as well as a client-side TCP process 18b in the client processor Y.

For every packet transmitted from a Server process Ps on processor X (with IP Address Ix) to a client process Pc on processor Y (with IP Address Iy), there is a unique TCP port number (S_Port) assigned to the TCP port on the Server process and another unique TCP port number (C_Port) assigned to the TCP port on the Client process. The S_Port is unique within the scope of the Server processor X with IP Address Ix, and the C_Port is unique within the scope of the Client processor Y with IP Address Iy).

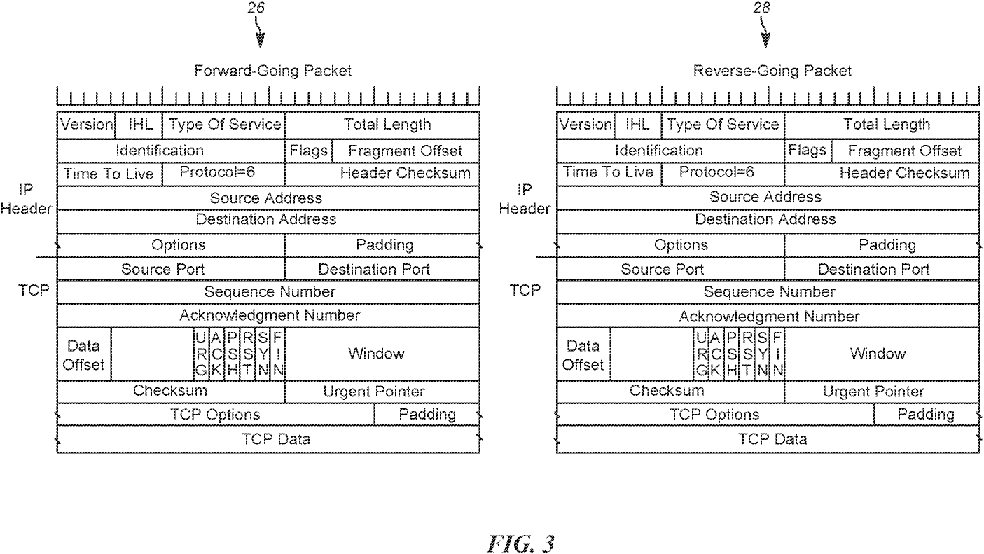

The TCP protocol used by the disclosed systems and methods utilizes a TCP “sequence value” (SEQ) associated with packet flows in each direction on the TCP connection between the server 12 and the client 14. A TCP Sequence Number is a 4-byte field in the TCP header (shown and described later in this specification wit respect to FIG. 3) that indicates the first byte of the outgoing segment and helps keep track of how much data has been transferred and received. The TCP Sequence Number field is always set, even when there is no data in the segment.

For the Left-to-Right (L2R) Flowing Packet Stream (shown in FIG. 1A) within a TCP Connection, there is a unique TCP Sequence Number (L2R Flow SEQ) included in every TCP Packet 20A (stored in the server 12 sending the packet) going from Left-to-Right, and there is a TCP Acknowledgement Number (L2R Flow ACK) included in every TCP Packet 20B (stored in the client 14) returned to the server upon receipt of the packet 20A. Conversely, for the Right-to-Left (R2L) Flowing Packet Stream (shown in FIG. 1B) within a TCP Connection, there is a unique TCP Sequence Number 20C (R2L Flow SEQ) included in every TCP Packet sent from the client 14 to the server 12 (the number stored in the client 14), and there is a TCP Acknowledgement Number (R2L Flow ACK) included in every TCP Packet 20D (stored in the server 12 14) returned to the client upon receipt of the packet 20C. Thus, there are a total of two SEQ numbers and two ACK numbers are preferably monitored by the disclosed systems and methods for an entire bidirectional TCP Connection- two for the L2R Flow and two for the R2L flow. All four numbers are typically different from one another.

Referring specifically to FIG. 1A, which shows a Packet with an SEQ number sent from the server 12 to the client 14, and a return acknowledgement (ACK) packet sent from the client 14 to the server 12, the SEQ Number associated with packet 20A starts with a randomly selected number (N0) in the first data packet sent from left to right i.e., SEQ = N0. Assume that the number of bytes in the first packet 20A’s payload is B0. Then the ACK number sent back from right to left is ACK = N0+B0. In this manner, the client 14 confirms that it has received the data conveyed in the packet 20A.

. The SEQ number of the next packet sent by the server will be N0+B0, i.e. each packet sent by the server 12 includes a SEQ number that is a running track of all the bytes sent in the process. Thus, the SEQ numbers of the packets sent by the server 12 are determined solely by the data stored on the server, and do not account for acknowledgments received from the client. Assuming that the number of bytes in the next data packet’s payload is B1, then the ACK number sent back from the client after receiving that packet would be ACK = N0+B0+B1, again keeping a running count of the bytes of all data received. Those of ordinary skill in the art will appreciate that ACKs can be piggybacked in a normal data packet or sent in their own packet.

Referring to FIG. 1B, the procedure just described is carried out in reverse, meaning that the client device 14 sends an initial packet 20D with an SEQ number of N0, and the server 12 responds with an acknowledgment packet 20D with an ACK number of N0 + B0 (the payload size of packet 20C), and so forth. Those of ordinary skill in the art will also appreciate that a separate acknowledgement packet need not be sent for each packet received. Referring to FIG. 1C, for example, if multiple packets (20A, 21A) arrive close in time to one another, then the receiver may only send an ACK that acknowledges both of the arrived packets. Alternatively, some receivers may send an ACK for every two (or predetermined number “n”) packets received, or may be configured to wait a certain window of time before sending an ACK.

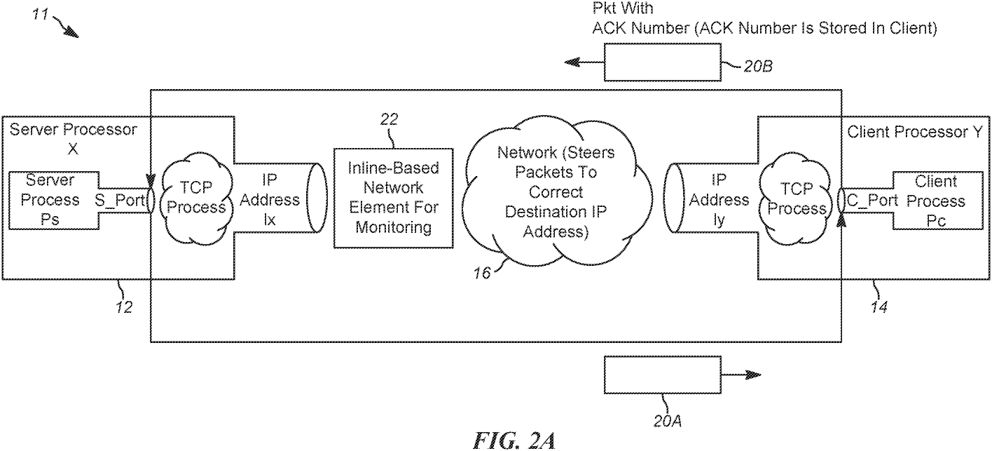

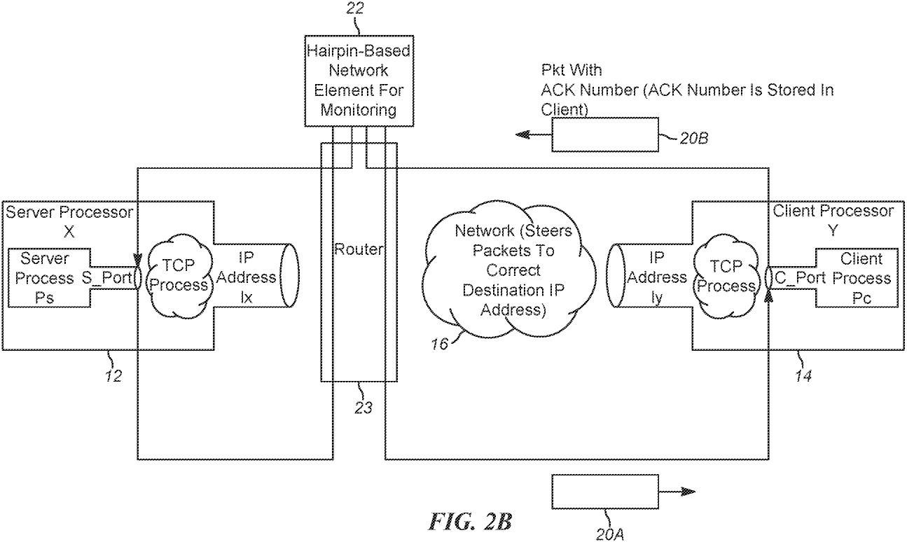

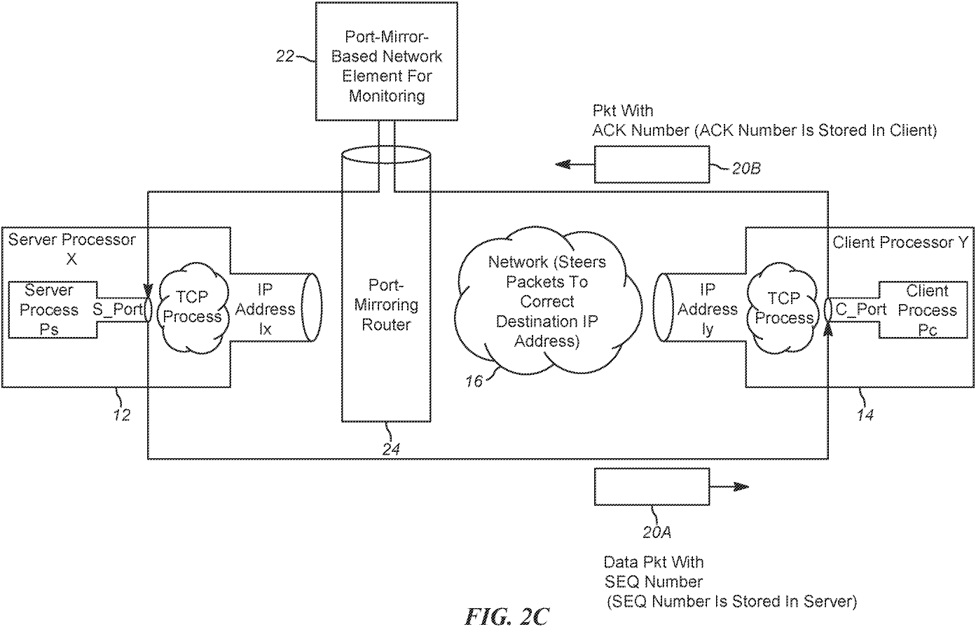

Disclosed in the present specification is a novel network monitoring unit 22 positioned at a location in a network that both monitors traffic exchanged between tow endpoints, to extract relevant data by which a lost packet may be detected, as well as divides the network into quadrants such that the quadrant in which the lost packet may be identified. Referring specifically to FIGS. 2A-2C, the disclosed network monitoring unit 22 is preferably positioned in a network proximate a boundary with a specific network that steers packets to a correct destination address. For example, many communications networks, such as the CATV networks previously described, receive packets via a packet-switched network (e.g., the Internet) and propagate such packets over a content delivery network (CDN) comprising fiber-optic cable, coaxial cable, or some combination of the two. Thus, the edge of this boundary represents one appropriate location for the disclosed network monitoring unit 22.

The network monitoring unit 22 may be positioned in a network in any appropriate manner. For example, FIG. 2A illustrates the network monitoring unit 22 positioned proximate the network 16 16 in an in-line arrangement that is directly interposed in the path between the network 16 and the server 12. FIG. 2B shows an alternate “hairpin” architecture where the network monitoring unit 22 is connected to a router 23 that itself is positioned in the path between the network 16 and the server 12. The router 23 is configured to send traffic, in either direction, to the network monitoring unit 22 and the network monitoring unit 22 in turn returns the received traffic to the router 23 after analysis. FIG. 2C shows still another, port-mirroring, architecture in which a port-mirroring router 24 mirrors (replicates) all packets propagating in either direction and sends the mirrored packets to the network monitoring unit 22. In this approach, the actual data paths do not pass through the network monitoring unit 22. The port-mirroring architecture has the benefit that if the network monitoring unit 22 malfunctions or goes offline, traffic between the server 12 and the client 14 is not interrupted.

FIG. 3 shows the fields of each packet’s TCP header that the network monitoring unit 22 monitors. Specifically, for both a forward going packet 26 and a reverse going acknowledgment packet, the network monitoring unit 22 monitors the source address, source port, destination address, destination port, and packet length. With respect to the forward going packet 26, the network monitoring unit 22 also extracts the SEQ number and with respect to the reverse-going packet 26 extracts the ACK number. With this data, the network monitoring unit 22 may correctly associate all received packets with their respective traffic flows, order them by their sequence/acknowledgment values, and detect whether there are any dropped packets.

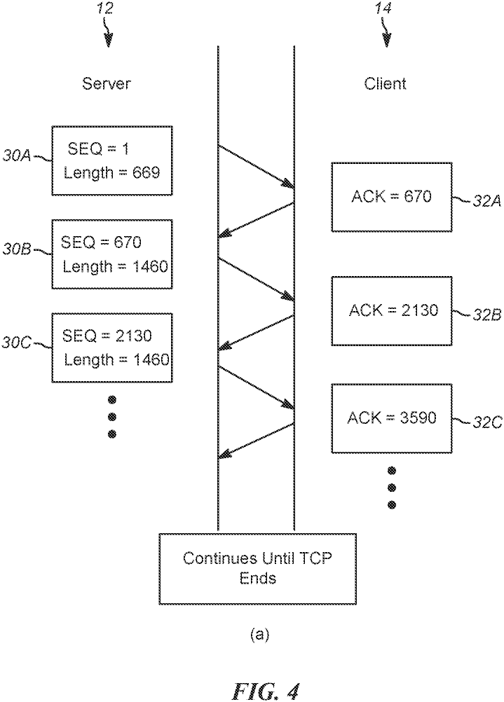

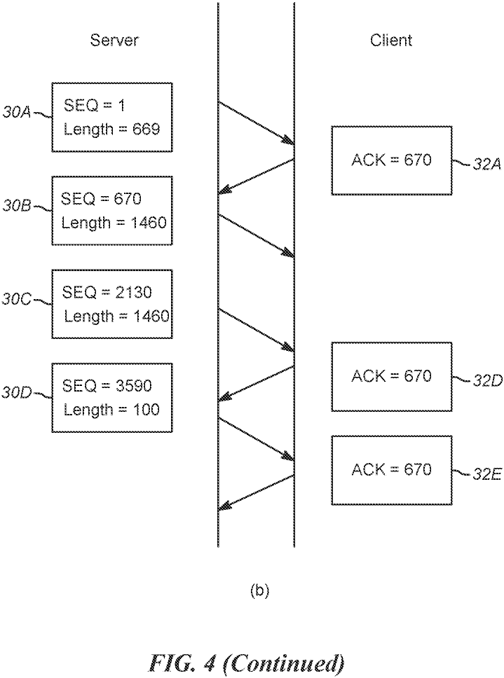

Referring to FIG. 4, for example, as seen in the left hand side of this figure, a server 12 may send a downstream packet 30A to a client device with a SEQ number of 1 and a length of 669. As indicated previously, the client 14 will acknowledge this packet with its own upstream packet 32A having and ACK number of 670 (669 + 1). The server then sends a second packet sends a second packet 30B with a SEQ number of 670 and a length of 1460, upon receipt of which the client 14 sends a return acknowledgment 32B with an ACK number of 2130 (1 + 669 + 1460). The server sends a third packet 30C with a SEQ number 2130 and a length of 1460 and the client 14 responds with acknowledgment packet 32C with an ACK number of 3590.

As can be seen in this procedure, both the server 12 and the client device 14 can easily determine whether any packets have not yet been acknowledged, perhaps have being dropped, simply by comparing adjacent SEQ/ACK numbers; every ACK packet received by a server should have a value that matches the SEQ number of a packet already, or to be sent and every packet with an SEQ number received from the client should match the ACK number of a response already sent.

The right side of FIG. 4, however, shows what happens when a packet is not received by the client 14. Specifically, assume that the second packet 30B with SEQ 670 and length 1460 is not received by the client device 14, and therefore no acknowledgment is sent immediately upon receipt. In this case, the client device 14 will receive the third packet 30 B with a SEQ number of 2130, which will not match the ACK number of the last acknowledgment packet 32A that the client device 14 had sent. The client device will then signal that it has not yet received the intervening packet 30B by sending an acknowledgment packet 32D with the same ACK value 670 as was in the acknowledgment 32A. This will continue until such time as the client device does receive the missing packet, either because of a delay in the network or because the packet was resent by the server 12. The client device 12 will continue to maintain a record of all packets received in the interim, with their SEQ numbers and payload sizes, so that when the missing packet is received, the client device may respond with one or more new acknowledgment packets that include ACK number(s) indicating the uninterrupted series of packets that it has received. For example, if the client device 14 receives the missing packet 30B at the same time, or just before receipt of packet 30D, it could simply send an acknowledgment packet 32E that included an ACK number 3690. This would inform the server that all packets through packet 30D had been received because the ACK number received by server 12 matches the SEQ number of packet 30D plus its length. Conversely, had another packet subsequent to packet 30B also not been received, the client device 30B could respond with an acknowledgment having an ACK number equal to the SEQ number plus the length of whatever packet was received, in the SEQ-numerical order immediately preceding that other, missed packet. In this manner, both the server 12 and the client device 14 may know which packets have been sent by the server 12 but have not yet been received.

The disclosed systems and methods provide for enhanced information about packet loss not previously attainable in the techniques previously described. The disclosed systems and methods not only identify when packet loss has occurred, but also are preferably capable of identifying the packet loss rate i.e., the number of packet losses occurring in the forward-going packet stream per second, and in some embodiments are also capable of estimating changes in average throughput of the forward-going packet stream resulting from the loss of a packet, which impacts the TCP Congestion Control Algorithm. The packet loss rate may be identified by dividing the packet loss count by the time of observation. The estimate of the change in average throughput may be determined by calculating the bps rate for a window of time before the packet loss occurred to the bps rate for a window of time after the packet loss occurred; the bps rates may for example calculated by dividing the total bytes passing by the time of observation.

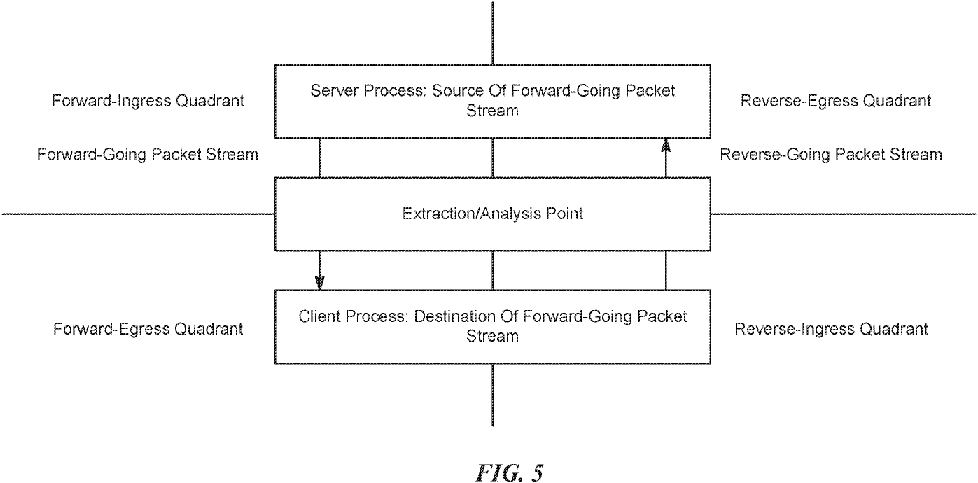

The disclosed systems and methods are also preferably capable of identifying locational information as to where the packet loss occurred, and in particular, identifying which one of the four quadrants, shown in FIG. 5, the packet loss occurred within. Specifically, the four quadrants are each defined relative to the location of the network monitoring unit 22 (shown as the “extraction/analysis point.” These four quadrants are defined as the Forward-Ingress, Forward-Egress, Reverse-Ingress, and Reverse-Egress quadrants relative to the point where the packets are extracted from their normal path for analysis. The quadrants are more particularly defined in reference to:
Forward-Ingress Quadrant Packet Loss: A packet loss that occurs in the path between the Source of the forward-going packet stream and the network monitoring unit 22;
Forward-Egress Quadrant Packet Loss: A packet loss that occurs in the path between the network monitoring unit 22and the Destination of the forward-going packet stream;
Reverse-Ingress Quadrant Packet Loss: A packet loss that occurs in the path between the Source of the reverse-going packet stream and the network monitoring unit 22; and
Reverse-Egress Quadrant Packet Loss: A packet loss that occurs in the path between the network monitoring unit 22 and the Destination of the reverse-going packet stream.
Knowing the quadrant in which a packet was lost helps determine where to search for problems e.g., Forward-Egress Quadrant implicates the DOCSIS downstream path, Reverse-Ingress Quadrant implicates the DOCSIS upstream path, Forward-Ingress Quadrant or Reverse-Egress Quadrant implicates the Internet, etc.

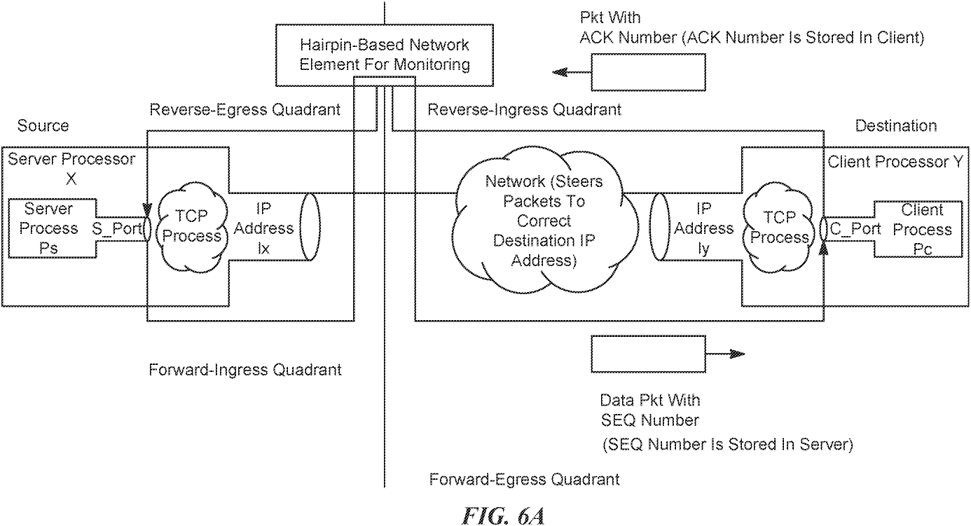

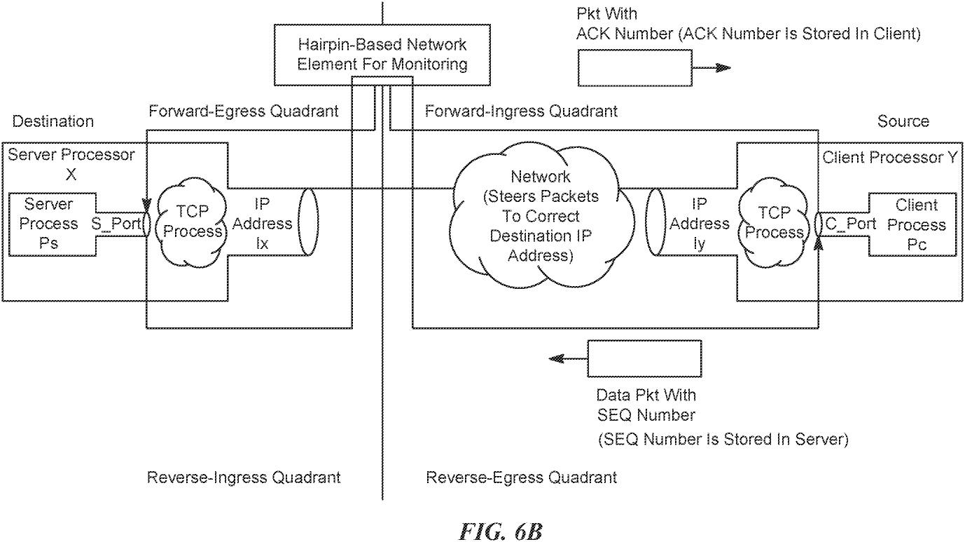

FIG. 6A maps the quadrants as just defined onto a downstream flow from server 12 to client device 14, while FIG. 6B maps the quadrants as just defined onto an upstream flow from client device 14 to the server 12. Several things should be noted about these figures, and thus the description given of the disclosed systems and methods. First, the “forward” and “reverse” flows referenced in this disclosure, as well as the terms “ingress” and egress” are made are made from the perspective of the disclosed network monitoring element. Thus, in reference to both FIGS. 6A and 6B, when a data-carrying packet is sent, for which an acknowledgement is to be received in the opposite or “reverse” direction, the “forward path ingress quadrant” refers to the ingress of those payload-carrying packets into the network monitoring element 22 and the “reverse path ingress quadrant” refers to the ingress into the network monitoring element of the “acknowledgement packets” in the opposite or “reverse” direction. This makes sense because from the perspective of the network monitoring element 22, the terms “server” and “client device” have no independent meaning; the network monitoring element only needs to distinguish between a transmitter of a packet and a receiver of the packet, which sends an acknowledgement in the opposite direction. Thus, FIGS. 6A and 6B are essentially the same figures, except in FIG. 6B the client device takes on the role of the “server” and vice versa.

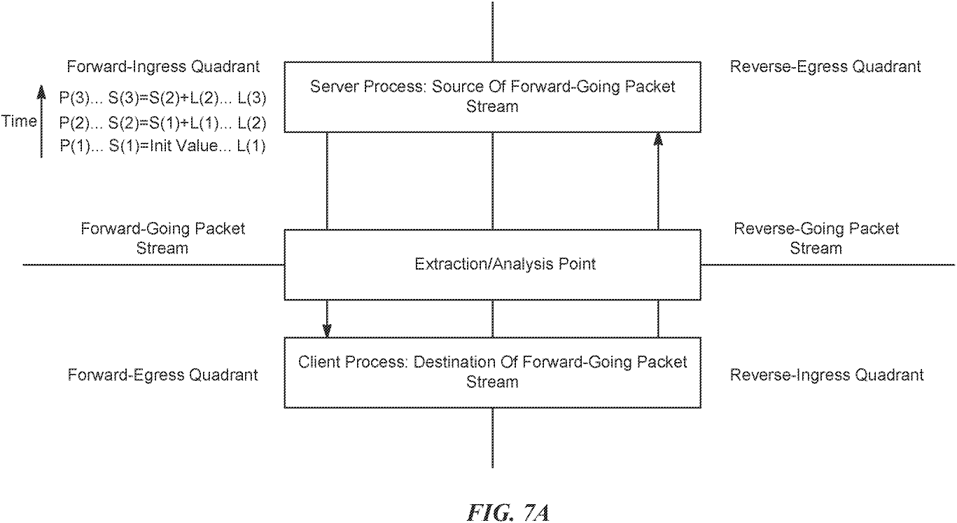

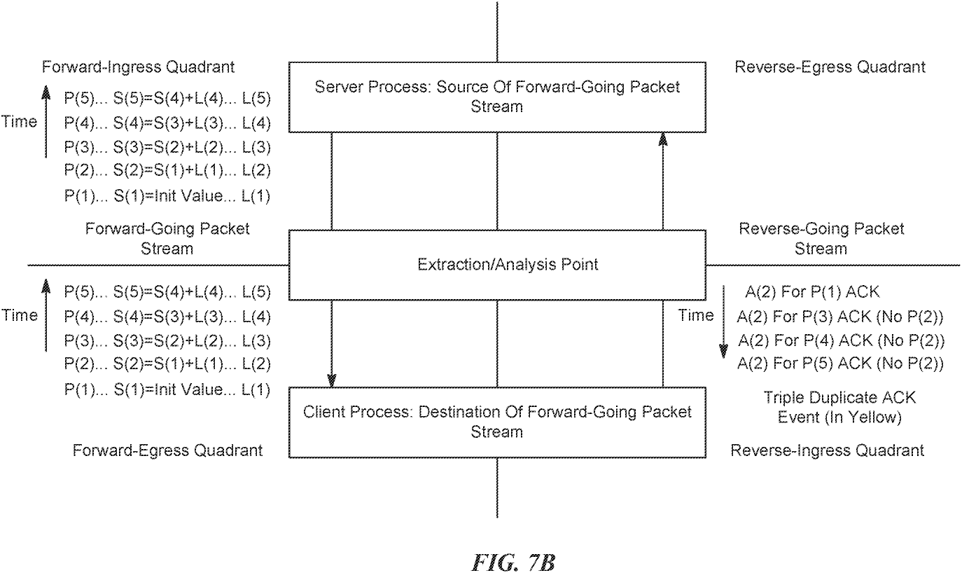

FIGS. 7A and 7B show a technique of determining whether a packet sent from a server 12 to a client device 14 was dropped in the forward ingress quadrant or the forward egress quadrant (the only two possibilities). Specifically, to determine if a packet was lost in the Forward-Ingress Quadrant, the network monitoring unit 22 monitors consecutively arriving packets in the forward-going packet stream. Assume for example in each of these figures that that the network monitoring unit 22 receives five consecutive packets (labeled P(1), P(2), P(3), P(4), and P(5)) and also assume that they have SEQ Numbers given by S(1), S(2), S(3), S(4), and S(5) and that the successive packets P(1), P(2), P(3), P(4), and P(5) have successive TCP Payloads with Lengths given by L(1), L(2), L(3), L(4), and L(5) respectively. The network monitoring unit 22 will record those SEQ Numbers S(1), S(2), S(3), S(4), and S(5), and therefore it is expected that the SEQ Number values will progress in the predetermined fashion... where SEQ Number S(2)=S(S1)+L(1), S(3)=S(2)+L(2), etc. i.e., the general formula is given by S(i+1) = S(i) + L(i).

If (at the network monitoring unit 22) the SEQ Number S(i+1) for a packet P(i+1) ever shows up and is greater than the predicted value that was predicted by the formula above, then that is likely to identify a packet loss that occurred in the Forward-Ingress Quadrant... where packet P(i+1) was actually dropped and the packet that came in at the apparent spot for P(i+1) is actually packet P(i+2) with the SEQ Number S(i+2). Typically, S(i+2) > S(i+1), so seeing that SEQ Number arrive as a value that is higher than expected is the trigger indicating that a packet may have been dropped in the Forward-Ingress Quadrant. As previously noted, there are circumstances when packets are delayed, but not dropped, when traversing a network, thus, the network monitoring unit 22 may not initially flag a packet as being dropped until three consecutive subsequent packets (i.e., packets P(3), P(4), and P(5)) have all been received without receipt of packet P(2). This example is analogous to employing the “triple duplicate acknowledgment” rule, but of course any other threshold may be used consistently with the disclosed system and methods.

Referring specifically to FIG. 7B, to determine if a packet was lost in the Forward-Egress Quadrant for packet streams sent in a downstream direction from server 12, the network monitoring unit 22 will monitor the consecutively arriving packets with ACKs in the reverse-going packet stream and check that the ACK Number progresses in the predicted fashion. Assuming for example that reverse-going ACK Value A(2) is sent in response to forward-going SEQ Value S(1) and Length L(1), because A(2) = S(1)+L(1), etc. If this predicted order of ACKs continues, then no packets were lost in the Forward-Egress Quadrant. However, if as is shown in FIG. 7B, where the packet P2 was dropped in the Forward Egress Quadrant, the value A(2) will be repeated for three or more times for forward-going packets with non-zero packet lengths (Li) - i.e., a Triple-Duplicate ACK event). In general, if any reverse-going ACK value A(i) is ever repeated for 3 or more times for forward-going packets with non-zero L(i) values, then that indicates that the forward-going packet with SEQ Number S(i) was likely dropped in the Forward-Egress Quadrant. Again, those of ordinary skill in the art will appreciate that the threshold number of three consecutive repeats may be varied without departing from the systems and methods disclosed herein. Furthermore, those of ordinary skill in the art will appreciate that the network monitoring unit 22 is preferably flexible enough to work even if ACKs are sent for every few forward packets- ex: if 2 packets are sent for every ACK, then P(1) and P(2) are transmitted before an ACK is sent with A(3) and then P(3) and P(4) will be sent before an ACK is sent with A(5).

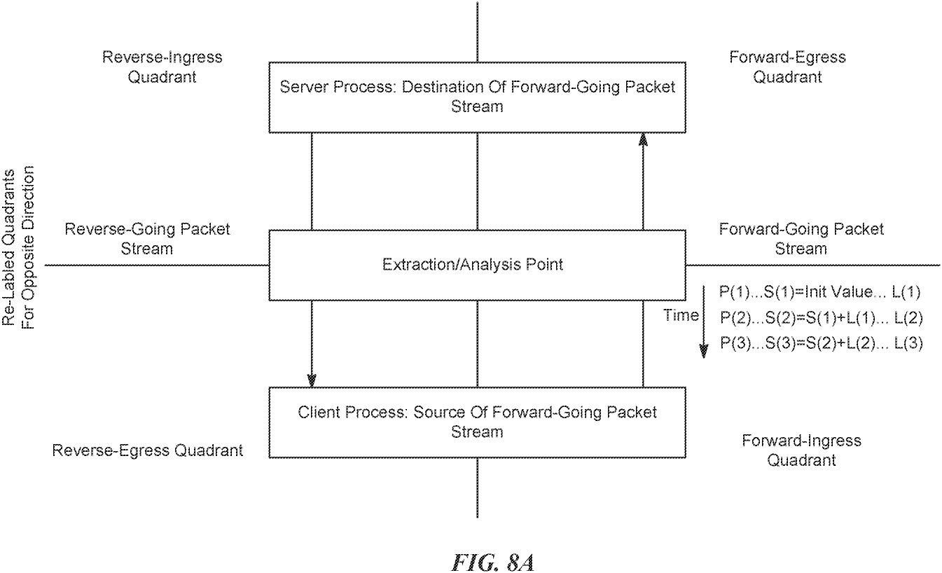

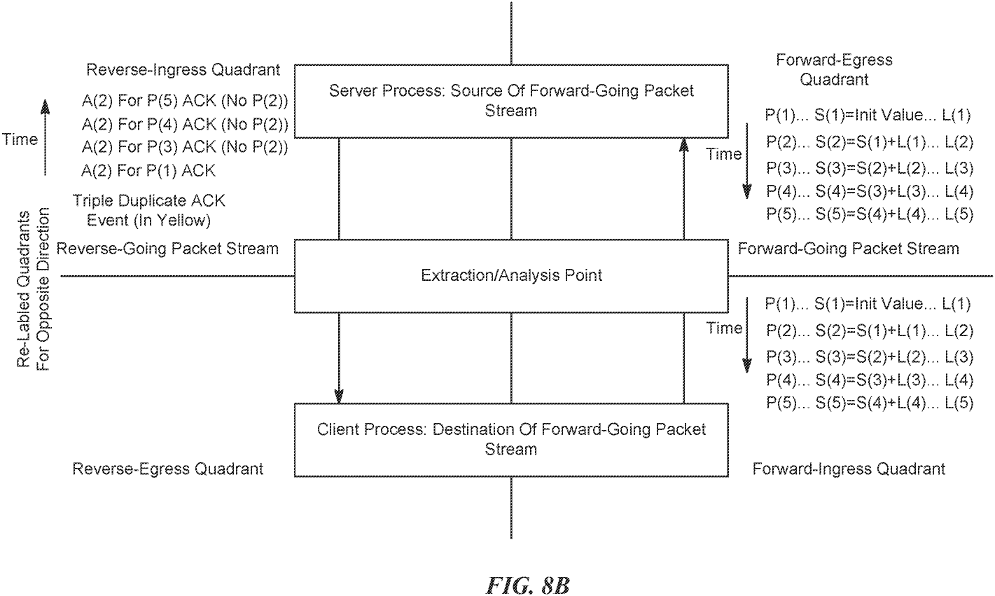

FIGS. 8A and 8B show how packet loss may be detected in the respective quadrants for upstream flows from a client device 14 to a server 12. Specifically, all than needs to be done is to reverse the view of packet streams and re-define pr re-label the quadrants as shown in these figures. Once re-labeled, the techniques described with respect to FIGS. 7A and 7B may be used identically to determine whether packet loss is associated with the Reverse-Ingress Quadrant or Reverse-Egress Quadrants shown in FIGS. 7A and 7B.

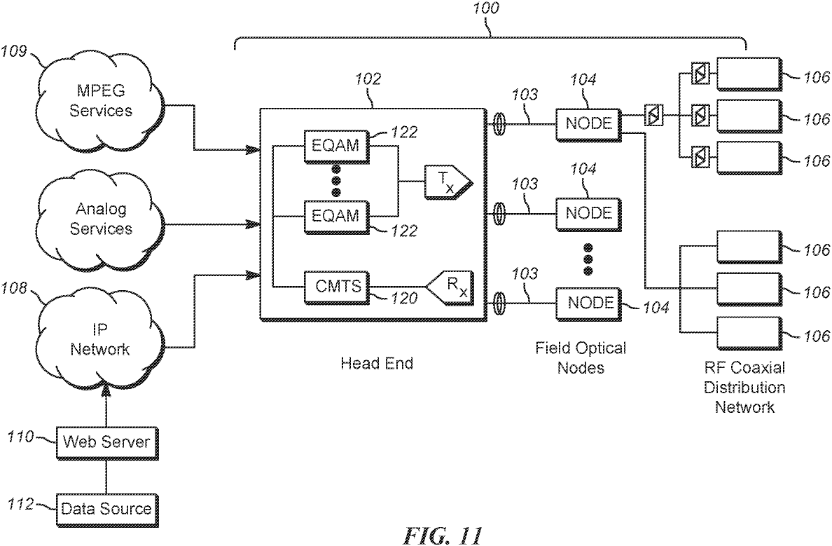

It should be noted that, although FIGS. 2A-2C, as well as FIGS. 5-8C show only one such network monitoring unit 22 that divides a communications network into quadrants, the systems and methods disclosed in this specification may be used to subdivide a network into more granular areas simply by employing more such network monitoring units 22. For example, and with reference to FIG. 11 which will be discussed in detail later in this specification, one network monitoring unit may be placed upstream of the head end, between the head end and the most proximate upstream router, while another network monitoring unit 22 may be placed just upstream of the nodes. In this manner, should it be determined that packets are being lost and the first network monitoring unit determines that the packets are being lost somewhere between the head end and the client device, the second network monitoring unit will be able to further narrow the location of the fault.

Similarly, both the server 12 and the client 14 may also be connected to a wide area network through respective content delivery networks (CDNs), and therefore some embodiments will have a first network monitoring unit 22 proximate the edge of the CDN serving the server, and a second network monitoring unit serving the client device.

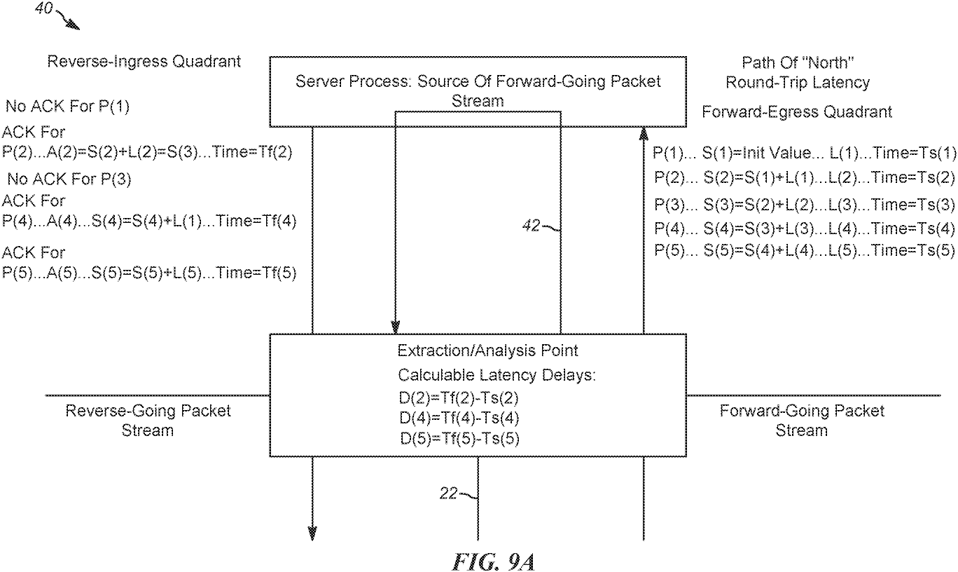

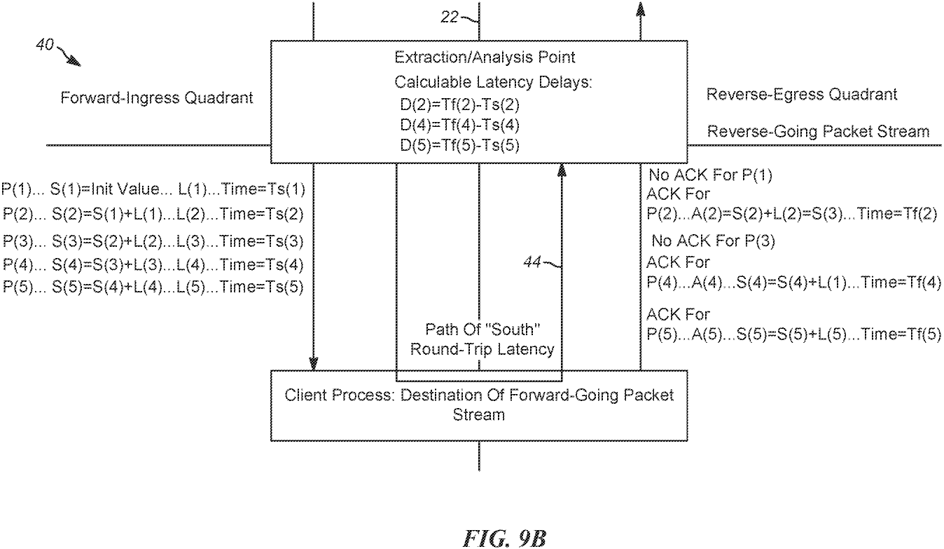

As noted earlier, in addition to dropped packets, network latency and jitter also degrade quality of service provided by communications networks. The disclosed network monitoring unit 22 is therefore also preferably capable of measuring the latency and jitter as packets traverse specific portions of a communications network. Referring for example to FIGS. 9A and 9B, which show a network 40 having a network monitoring unit that divides the network 40 into the four quadrants as previously described. The network monitoring unit 22 is preferably capable of measuring the latency experienced in a “north round trip” 42 of the network as packets leave the network monitoring unit 22 and enter the server 12 and as packets leave the server 42 and enter the network monitoring unit 22 (as shown in FIG. 9A). Similarly, the network monitoring unit is preferably capable of measuring the latency experienced in a “south round trip” 42 of the network as packets leave the network monitoring unit 22 and enter the client device 14 and as packets leave the client device 14 and enter the network monitoring unit 22 (as shown in FIG. 9B).

Thus, the north round trip latency 42 adds together the latency in the Reverse-Egress Quadrant, the packet processing delay in the server 12, and the latency in the Forward-Ingress Quadrant, Similarly, the south round trip latency 44 adds together the latency in the Forward-Egress Quadrant, the packet processing delay in the client device 14, and the latency in the Reverse-Ingress Quadrant. Those of ordinary skill in the art will recognize that the packets leaving the network monitoring unit are not the same packets returning in either of these “round trips.”

Determining the north round-trip latency 42 and south round-trip latency 44 at the network monitoring unit 22 can help operators determine where excessive latency is occurring in a network with latency issues. This can help to steer maintenance personnel directly to problems. For example, in a DOCSIS network with the network monitoring unit 22 near the CMTS, north latency issues point to the Internet as the source of the problem, while South latency issues point to the DOCSIS network as the source of the problem.

As just noted, embodiments of the disclosed network monitoring unit may preferably be capable of measuring the north round trip latency 42. Specifically, for every packet entering from the client device 14 - i.e., packets going from south-to-north, the network monitoring unit may record the SEQ Number S(i), the TCP Payload Length L(i), and the start timestamp Ts(i) when the packet passed through the network monitoring unit 22. Also, the network monitoring unit 22 may preferably store the packet’s Source IP, Dest IP, Source Port, Dest Port, and Protocol (TCP or UDP), collectively referred to as a “5-tuple.” Similarly, for every acknowledgment entering the network monitoring unit from the server 12, i.e., packets going from north-to-south, the network monitoring unit 22 may record the ACK Number A(i) and the final timestamp Tf(i) when the packet passed by the network monitoring unit 22. Also, the network monitoring unit 22 may preferably store the Source IP, Dest IP, Source Port, Dest Port, and Protocol (TCP or UDP) of the packets (the “5-tuple” containing these acknowledgments.

With this information, the network monitoring unit may, for each ACK number monitored within a particular 5-tuple, calculate the associated “north round trip” Latency Delay time D(i) as being D(i)=Tf(i)-Ts(i). All of the calculated Latency Delay times D(i) may be stored, along with various statistics (avg, min, max, pdf) that can be calculated from the collection of latency delay times.

Embodiments of the disclosed network monitoring unit may preferably also be capable of measuring the south round trip latency 44. Specifically, for every packet entering from the server 12 - i.e., packets going from north-to-south, the network monitoring unit may record the SEQ Number S(i), the TCP Payload Length L(i), and the start timestamp Ts(i) of when the packet passed through the network monitoring unit 22. Also, the network monitoring unit may preferably store the packet’s Source IP, Dest IP, Source Port, Dest Port, and Protocol (TCP or UDP). Similarly, for every acknowledgment entering the network monitoring unit from the client 14, i.e., packets going from south-to-north, the network monitoring unit 22 may record the ACK Number A(i) and the final timestamp Tf(i) when the packet passed through the network monitoring unit 22. Also, the network monitoring unit 22 may preferably store the Source IP, Dest IP, Source Port, Dest Port, and Protocol (TCP or UDP) of the packets containing these acknowledgments.

With this information, the network monitoring unit may, for each ACK number monitored within a particular 5-tuple, calculate the associated “south round trip” Latency Delay time D(i) as being D(i)=Tf(i)-Ts(i). All the calculated Latency Delay times D(i) may be stored, along with various statistics (avg, min, max, pdf) that can be calculated from the collection of latency delay times.

With respect to measuring performance characteristics related to jitter, along with the location of a source of such jitter, one technique may simply be approximated based on the foregoing latency measurements by calculating the maximum latency minus the minimum latency over sequential temporal windows Twi. Disclosed, however, are other embodiments that determine jitter statistics in more detail. Such disclosed embodiments collect data in a manner similar to that with respect to latency as described above, meaning that data-collection/calculations are performed on a 5-tuple basis and that measurements are made with respect to a northbound round-trip jitter and a southbound round-trip jitter, thereby permitting location of the source of the jitter.

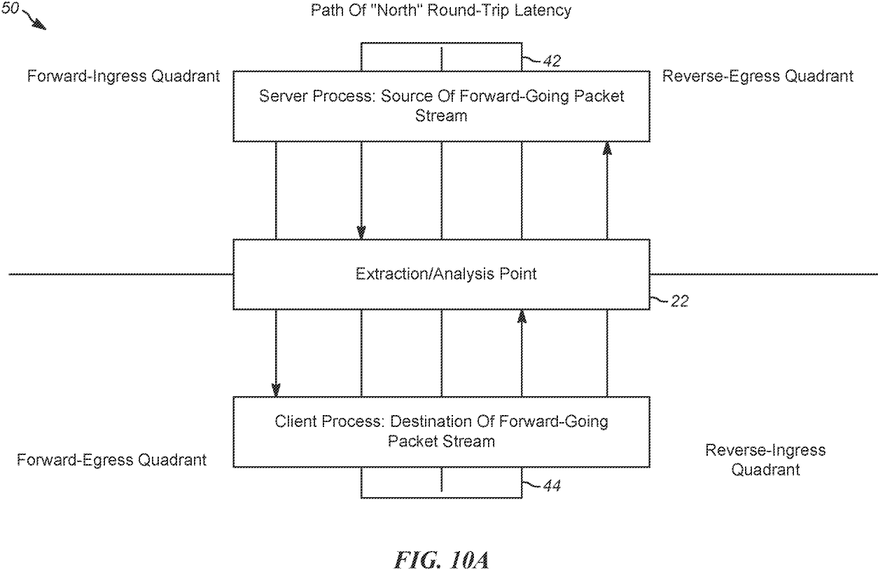

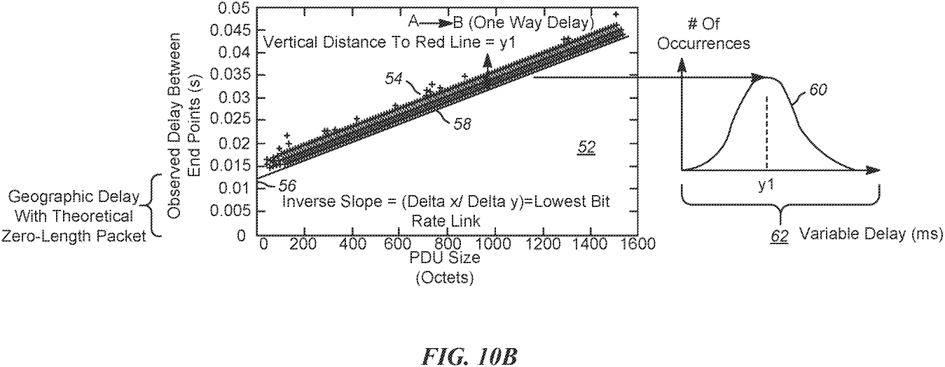

Specifically, for purposes of illustration and in reference to FIG. 10A, a north-round trip latency delay may be measured by a system 50 using timestamps for packets passing in the forward-going direction and timestamps for ACKs passing in the reverse-going direction. For every packet entering the network monitoring unit 22 from the client device 14 - i.e., packets going from south-to-north, the network monitoring unit 22 may record the SEQ Number S(i), the TCP Payload Length L(i), and the start timestamp Ts(i) when the packet passed through the network monitoring unit 22. Also, the network monitoring unit 22 may preferably store the packet’s Source IP, Dest IP, Source Port, Dest Port, and Protocol (TCP or UDP), collectively referred to as a “5-tuple.” Similarly, for every acknowledgment entering the network monitoring unit 22 from the server 12, i.e., packets going from north-to-south, the network monitoring unit 22 may record the ACK Number A(i) and the final timestamp Tf(i) when the packet passed by the network monitoring unit 22. Also, the network monitoring unit 22 may preferably store the Source IP, Dest IP, Source Port, Dest Port, and Protocol (TCP or UDP) of the packets (the “5-tuple” containing these acknowledgments.

With this information, the network monitoring unit may, for each ACK number monitored within a particular 5-tuple, calculate the associated “north round trip” Latency Delay time D(i) as being D(i)=Tf(i)-Ts(i). All of the calculated Latency Delay times D(i) may be stored.

From this stored data, the network monitoring unit may preferably collect a variety of statistics related to delay and jitter that occurs over the north-round-trip segment of the quadrants shown in FIG. 10A. Specifically, the following metrics may be collected:
Geographic Delay - the delay of a theoretical zero-length packet, associated with the distance traversed regardless of processing, buffering etc.
Serialization Delay - the time that it takes to serialize a packet, meaning how long time it takes to physically put the packet on the wire.
Variable Delay - a combination of queuing delays that result from buffering packets and processing delays related to processing packets.

Referring to FIG. 10B, each of these delays may be calculated by initially, for each 5-tuple that was monitored and that has stored D(i) & L(i) value pairs, create a single scatter plot 52 with D(i) on the y-axis (north round trip delay) and with L(i) (payload length) on the x-axis. The result for a single 5-tuple (subscriber flow) will look something like the scattered data 54 shown in FIG. 10B. The geographic delay is calculated as the y-intercept 56 of a line 58 that bounds the scattered data at that data’s lower boundary. The inverse-slope of this line 58 (Δx/Δy) represents the bit-rate of the lowest bit-rate link that the packet flow experiences in the north-round-trip path. The serialization delay for a packet may be calculated by multiplying this slope by its packet size. The variable delay for any given packet may be calculated by to the line 58.

The variable delay for all packets in the scatter plot may be plotted as a probability mass function (pmf) 60, which charts the number of occurrences (y-axis) in the data set of packets of a particular variable delay (x-axis). From pmf 60, statistics may be collected (mean, mode, min, max, std deviation, etc) for the variable delay for that particular flow. This process can be repeated for other 5-tuple flows, and the results can be blended and compared. Jitter for a particular packet flow is measured as the x-axis width 62 of the pmf 60. A pmf 60 of vertical distances to the line 58 for all points in all of the delay vs packet length scatter plots for all 5-tuple flows creates average jitter statistics for all subscribers, in the north-round trip portion of the network..

Those of ordinary skill in the art wis appreciate that the procedure that was just described with respect to the north-round-trip of the network may be repeated with respect to the south round-trip portion of the network.

FIG. 11 shows a Hybrid Fiber Coaxial (HFC) broadband network 100 that may employ the various embodiments described in this specification. The HFC network 100 may combines the use of optical fiber and coaxial connections. The network 100 includes a head end 102 that receives analog or digital video signals and digital bit streams representing different services (e.g., video, voice, and Internet) from various digital information sources. For example, the head end 102 may receive content from one or more video on demand (VOD) servers, IPTV broadcast video servers, Internet video sources, or other suitable sources for providing IP content.

An IP network 108 may include a web server 110 and a data source 112. The web server 110 is a streaming server that uses the IP protocol to deliver video-on-demand, audio-on-demand, and pay-per view streams to the IP network 108. The IP data source 112 may be connected to a regional area or backbone network (not shown) that transmits IP content. For example, the regional area network can be or include the Internet or an IP-based network, a computer network, a web-based network or other suitable wired or wireless network or network system.

At the head end 102, the various services are encoded, modulated and up-converted onto RF carriers, combined onto a single electrical signal and inserted into a broadband optical transmitter. A fiber optic network extends from the cable operator’s master/regional head end 102 to a plurality of fiber optic nodes 104. The head end 102 may contain an optical transmitter or transceiver to provide optical communications through optical fibers 103. Regional head ends and/or neighborhood hub sites may also exist between the head end and one or more nodes. The fiber optic portion of the example HFC network 100 extends from the head end 102 to the regional head end/hub and/or to a plurality of nodes 104. The optical transmitter converts the electrical signal to a downstream optically modulated signal that is sent to the nodes. In turn, the optical nodes convert inbound signals to RF energy and return RF signals to optical signals along a return path.

Each node 104 serves a service group comprising one or more customer locations. By way of example, a single node 104 may be connected to thousands of cable modems or other subscriber devices 106. In an example, a fiber node may serve between one and two thousand or more customer locations. In an HFC network, the fiber optic node 104 may be connected to a plurality of subscriber devices 106 via coaxial cable cascade 111, though those of ordinary skill in the art will appreciate that the coaxial cascade may comprise a combination of fiber optic cable and coaxial cable. In some implementations, each node 104 may include a broadband optical receiver to convert the downstream optically modulated signal received from the head end or a hub to an electrical signal provided to the subscribers’ devices 106 through the coaxial cascade 111. Signals may pass from the node 104 to the subscriber devices 106 via the RF cascade of amplifiers, which may be comprised of multiple amplifiers and active or passive devices including cabling, taps, splitters, and in-line equalizers. It should be understood that the amplifiers in the RF cascade may be bidirectional, and may be cascaded such that an amplifier may not only feed an amplifier further along in the cascade but may also feed a large number of subscribers. The tap is the customer’s drop interface to the coaxial system. Taps are designed in various values to allow amplitude consistency along the distribution system.

The subscriber devices 106 may reside at a customer location, such as a home of a cable subscriber, and are connected to the cable modem termination system (CMTS) 120 or comparable component located in a head end. A client device 106 may be a modem, e.g., cable modem, MTA (media terminal adaptor), set top box, terminal device, television equipped with set top box, Data Over Cable Service Interface Specification (DOCSIS) terminal device, customer premises equipment (CPE), router, or similar electronic client, end, or terminal devices of subscribers. For example, cable modems and IP set top boxes may support data connection to the Internet and other computer networks via the cable network, and the cable network provides bi-directional communication systems in which data can be sent downstream from the head end to a subscriber and upstream from a subscriber to the head end.

References are made in the present disclosure to a Cable Modem Termination System (CMTS) in the head end 102. In general, the CMTS is a component located at the head end or hub site of the network that exchanges signals between the head end and client devices within the cable network infrastructure. In an example DOCSIS arrangement, for example, the CMTS and the cable modem may be the endpoints of the DOCSIS protocol, with the hybrid fiber coax (HFC) cable plant transmitting information between these endpoints. It will be appreciated that architecture 100 includes one CMTS for illustrative purposes only, as it is in fact customary that multiple CMTSs and their Cable Modems are managed through the management network.

The CMTS 120 hosts downstream and upstream ports and contains numerous receivers, each receiver handling communications between hundreds of end user network elements connected to the broadband network. For example, each CMTS 120 may be connected to several modems of many subscribers, e.g., a single CMTS may be connected to hundreds of modems that vary widely in communication characteristics. In many instances several nodes, such as fiber optic nodes 104, may serve a particular area of a town or city. DOCSIS enables IP packets to pass between devices on either side of the link between the CMTS and the cable modem.

It should be understood that the CMTS is a non-limiting example of a component in the cable network that may be used to exchange signals between the head end and subscriber devices 106 within the cable network infrastructure. For example, other non-limiting examples include a Modular CMTS (M-CMTSTM) architecture or a Converged Cable Access Platform (CCAP).

An EdgeQAM (EQAM) 122 or EQAM modulator may be in the head end or hub device for receiving packets of digital content, such as video or data, re-packetizing the digital content into an MPEG transport stream, and digitally modulating the digital transport stream onto a downstream RF carrier using Quadrature Amplitude Modulation (QAM). EdgeQAMs may be used for both digital broadcast, and DOCSIS downstream transmission. In CMTS or M-CMTS implementations, data and video QAMs may be implemented on separately managed and controlled platforms. In CCAP implementations, the CMTS and edge QAM functionality may be combined in one hardware solution, thereby combining data and video delivery.

The techniques disclosed herein may be applied to systems compliant with DOCSIS. The cable industry developed the international Data Over Cable System Interface Specification (DOCSIS®) standard or protocol to enable the delivery of IP data packets over cable systems. In general, DOCSIS defines the communications and operations support interface requirements for a data over cable system. For example, DOCIS defines the interface requirements for cable modems involved in high-speed data distribution over cable television system networks. However, it should be understood that the techniques disclosed herein may apply to any system for digital services transmission, such as digital video or Ethernet PON over Coax (EPoc). Examples herein referring to DOCSIS are illustrative and representative of the application of the techniques to a broad range of services carried over coax

Those of ordinary skill in the art will also recognize that the architecture of FIG. 11 is exemplary, as other communications architectures, such as a PON architecture, Fiber-to-the-Home, Radio-Frequency over Glass (RFoG), and distributed architectures having remote devices such as RPDs, RMDs, ONUs, ONTs, etc. may also benefit from the disclosed systems and methods. For example, in a remote architecture where an RPD and/or RMD has an ethernet connection toa packet-switched network at its northbound interface and delivers a modulated signal at its southbound interface to subscribers, the disclosed network monitoring unit 22 may be positioned between the remote device (RPD or RMD) and a router immediately to the north of it.

Similarly, those of ordinary skill in the art will recognize that, although many embodiments were described in relation to the hairpin architecture of FIG. 2B, other architectures such as the inline architecture of FIG. 2A and the port-mirroring architecture of FIG. 2C may also be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. An apparatus operatively connected between a sending device and a receiving device that together exchange a sequence of packets in a communications network, the apparatus comprising:
a first ingress port and a first egress port, each connected to the sending device;
a second ingress port and a second egress port each connected to the receiving device; and
a processor that processes packets exchanged between the sending device and the receiving device in a manner that determines both the existence of, and location where, packets were dropped in transit between the sending device and the receiving device.

2. The apparatus of claim 1 configured to examine the TCP header of packets exchanged between the sending device and receiving device to determine the location where packets were dropped.

3. The apparatus of claim 1 where the determined location is a quadrant of the communications network.

4. The apparatus of claim 3 where the quadrant is a selected one of four quadrants, each associated with one of the first ingress port, the second ingress port, the first egress port, and the second egress port.

5. The apparatus of claim 1 located proximate the boundary between a content delivery network and a packet-switched network.

6. The apparatus of claim 5 where the packet switched network is the Internet.

7. The apparatus of claim 1 where the processor identifies the location where packets were dropped by comparing values in a field of respective headers of sequentially received packets, the field being a selected one of an SEQ field or an ACK field.

8. A method performed by an apparatus operatively connected between a first device and a second device that together exchange a sequence of packets in a communications network, the method comprising:
intercepting a first series of first packets from the first device that are communicated to the second device, and a series of second packets from the second device that are communicated to the second device;
analyzing at least one of the first series of packets and the second series of packets; and
based on the analysis, determining both the existence of, and location where, packets were dropped in transit between the sending device and the receiving device.

9. The method of claim 8 where the second series of packets acknowledge receipt of the first series of packets.

10. The method of claim 8 where the determined location is a quadrant of the communications network.

11. The method of claim 10 where a first quadrant of the communications network is determined as the location based on a comparison between fields of sequential ones of the first series of packets while a second quadrant of the network is determined as the location based on a comparison between fields of sequential ones of the first series of packets.

12. The method of claim 10 where a quadrant of the communications network is determined as the location based on a comparison between SEQ fields of sequential ones of the first series of packets.

13. The method of claim 12 where a second quadrant of the communications network is determined as the location based on a comparison between ACK fields of sequential ones of the second series of packets.

14. The method of claim 8 where the apparatus is located proximate the boundary between a content delivery network and a packet-switched network.

15. The method of claim 14 where the packet switched network is the Internet.
